(19) United States
(12) Patent Application Publication
(10) Pub. No.: US 2012/0305729 A1
(43) Pub. Date: Dec. 6, 2012

(54) Bracket And Lockable Storage Box System Incorporating Same

(75) Inventor: Stephen William Huber, Bettendorf, IA (US)

(73) Assignee: Twin State Design Products LLC

(21) Appl. No.: 13/150,870

(22) Filed: Jun. 1, 2011

(51) Int. Cl. F16M 13/00

(52) U.S. Cl. 248/311.2

(57) ABSTRACT

Brackets for use in securing portable locking storage boxes and other items are disclosed herein, along with systems that include such brackets. According to one embodiment, a bracket for use in securing a portable locking item includes a pair of proximal portions, an outwardly-extending distal portion between the proximal portions, and a pair of transition portions. Each proximal portion has an interaction face and at least one aperture for passing a fastener therethrough. The proximal portion interaction faces are generally parallel and coplanar with one another. The distal portion has a pair of sidewalls spaced apart from one another. A respective transition portion is between each proximal portion and the distal portion, and each transition portion has an interaction face extending at an angle from a respective proximal portion interaction face to a respective distal portion sidewall.

### BACKGROUND

The invention relates to the field of coupling objects together, and to the field of lockable storage box systems that may be temporarily or permanently affixed to environmental objects.

There is a need for securing personal items from theft, and particularly in communal living environments such as dormitories. Traditional portable lockable storage boxes (or “safes”) are often ineffective, as they may be stolen and opened later at the thief's leisure. Recognizing that fact, brackets have been created to attach safe systems to larger objects, such as furniture, that are not easily removed without causing a disturbance. Such brackets and safe systems are disclosed, for example, in US 2009/0044736, the contents of which are incorporated by reference herein. The current invention improves upon the prior art by allowing non-marring attachment to a large variety of environmental objects.

### SUMMARY

Brackets for use in securing portable locking storage boxes and other items are disclosed herein, along with systems that include such brackets. According to one embodiment, a bracket for use in securing a portable locking item includes a pair of proximal portions, an outwardly-extending distal portion between the proximal portions, and a pair of transition portions. Each proximal portion has an interaction face and at least one aperture for passing a fastener therethrough. The proximal portion interaction faces are generally parallel and coplanar with one another. The distal portion has a pair of sidewalls spaced apart from one another. A respective transition portion is between each proximal portion and the distal portion, and each transition portion has an interaction face extending at an angle from a respective proximal portion interaction face to a respective distal portion sidewall.

According to another embodiment, a bracket for use in securing a portable locking item includes first and second proximal portions, an outwardly-extending distal portion between the proximal portions, a first transition portion between the first proximal portion and the distal portion; and a second transition portion between the second proximal portion and the distal portion. The proximal portions are configured to simultaneously contact a generally planar environmental item, and each proximal portion has at least one aperture for passing a fastener therethrough. The distal portion is configured to receive one leg of an L-shaped environmental item therein. The first and second transition portions collectively present a pair of faces angled relative to one another for simultaneously contacting a generally cylindrical environmental item.

### BRIEF DESCRIPTION OF THE DRAWINGS

Illustrative embodiments of the present invention are described in detail below with reference to the attached drawings.

FIG. 1 is a perspective view of a bracket for use with a portable lockable storage box, according to an embodiment.

FIG. 2 is a front view of the bracket of FIG. 1.

FIG. 3 is a back view of the bracket of FIG. 1.

FIG. 4 is a side view of the bracket of FIG. 1.

FIG. 5 is a perspective view of the bracket of FIG. 1, in use with a portable locking storage box according to an embodiment, shown coupled to a horizontal flat post.

FIG. 6 is a perspective view of the bracket and box of FIG. 5, shown coupled to a vertical flat post.

FIG. 7 is a perspective view of the bracket and box of FIG. 5, shown coupled to a horizontal round post.

FIG. 8 is a perspective view of the bracket and box of FIG. 5, shown coupled to a vertical round post.

FIG. 9 is a perspective view of the bracket and box of FIG. 5, shown coupled to a horizontal L-shaped frame.

FIG. 10 is a perspective view of the bracket and box of FIG. 5, shown coupled to a vertical L-shaped frame.

FIG. 11 is a perspective view of the bracket of FIG. 1, in use with a portable locking storage box according to another embodiment, shown coupled to a horizontal flat post.

FIG. 12 is a perspective view of the bracket and box of FIG. 11, shown coupled to a vertical flat post.

FIG. 13 is a perspective view of the bracket and box of FIG. 11, shown coupled to a horizontal round post.

FIG. 14 is a perspective view of the bracket and box of FIG. 11, shown coupled to a vertical round post.

FIG. 15 is a perspective view of the bracket and box of FIG. 11, shown coupled to a horizontal L-shaped frame.

FIG. 16 is a perspective view of the bracket and box of FIG. 11, shown coupled to a vertical L-shaped frame.

### DETAILED DESCRIPTION

Embodiments of the present invention provide brackets for use in securing portable locking storage boxes and other items, and systems that include such brackets.

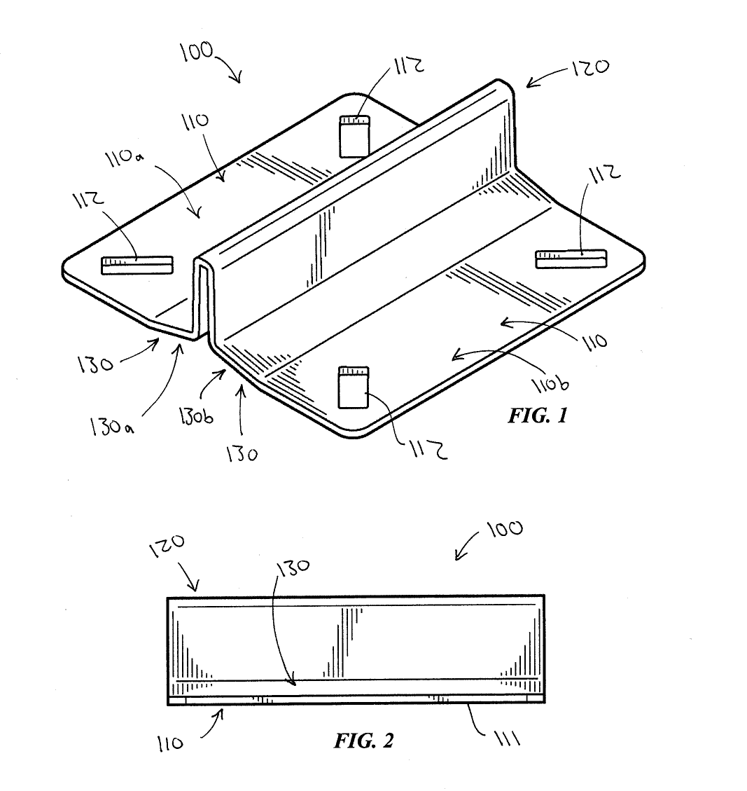

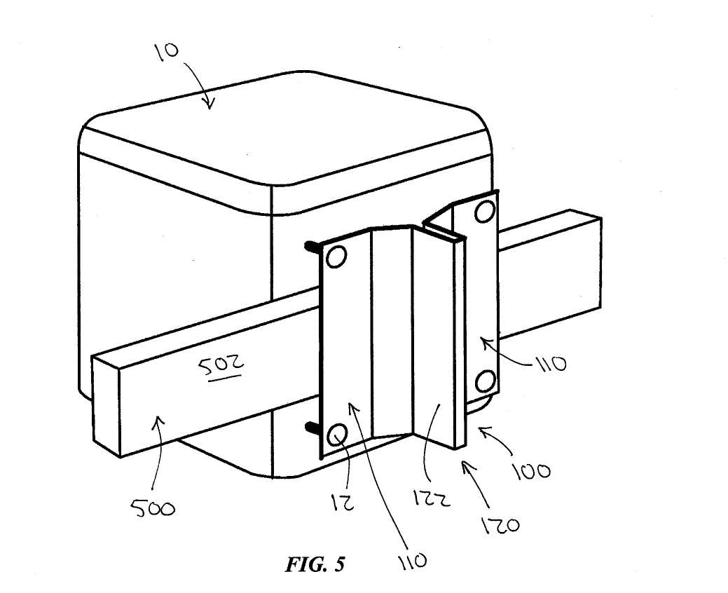

As shown in FIGS. 1 through 4, a bracket 100 according to one embodiment includes a pair of proximal portions 110 (identified respectively with reference numbers 110a, 110b) that are separated by an outwardly-extending distal portion 120. A respective transition portion 130 (identified respectively with reference numbers 130a, 130b) is between each proximal portion 110 and the distal portion 120.

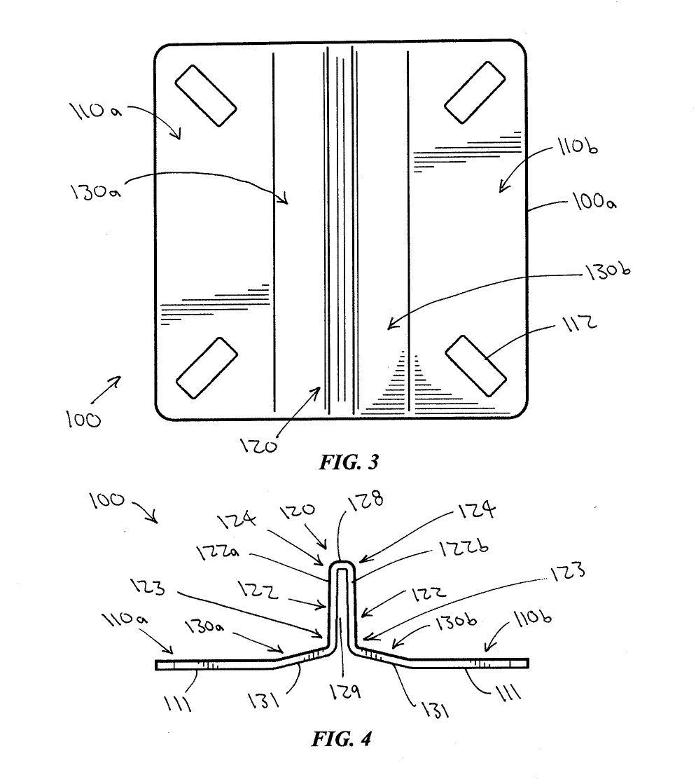

The proximal portions 110 each have an interaction face 111 that are generally parallel and coplanar with one another, and each proximal portion 110 includes at least one aperture 112. While the apertures 112 may be located and positioned in various ways, in FIG. 3 two generally rectangular apertures 112 are shown in each proximal portion 110, and the apertures 112 are spaced apart and positioned such that center axes of the apertures 112 in one proximal portion 110 are not parallel to one another, and are generally aligned with center axes of the apertures 112 in the other proximal portion 110. Moreover, the apertures 112 are generally equally spaced from a perimeter 100a of the bracket 100. The perimeter 100a shown in FIG. 3 is generally rectangular and includes rounded corners.

Turning now to the distal portion 120, the distal portion 120 has a pair of walls 122 (identified respectively with reference numbers 122a, 122b) spaced apart from one another. Each wall 122 has a proximal end 123 and a distal end 124, and the distal ends 124 are coupled together by an end wall 128. It may be desirable for the walls 122 to be generally parallel to one another, or for the walls 122 to be flared away from the distal ends 124. The walls 122 may be spaced apart at varying distances in different embodiments, depending particularly on the intended operating environment for the bracket 100, but it may be desirable for the walls 122 of each particular bracket 100 to be generally fixed relative to one another. Regardless of the spacing, a cavity 129 is defined between the walls 122.

Each of the transition portions 130 has an interaction face 131 extending at an angle (i.e., an angle that is not zero degrees) from a respective interaction face 111 and at an angle (i.e., an angle that is not zero degrees) from the walls 122. The interaction faces 131 may each be generally planar, and may be generally mirror images of one another about the distal portion 120.

The bracket 100 may be constructed from one or more pieces of material using various manufacturing method. For example, the bracket 100 may be constructed of a single unitary piece of material, and the proximal portions 110, the distal portion 120, and the transition portions 130 may be defined by a stamping or other bending process. Numerous materials may be used to construct the bracket 100, such as metals, plastics, and composites.

The configuration of the bracket 100 may be particularly useful in allowing the bracket 100 to be coupled to various environmental objects. Attention is now directed to FIGS. 5 through 10, which show the bracket 100 in different examples of use. In these figures, a portable safe 10 and bolts 12 are shown with the bracket 100. The safe 10 may be, for example, similar to storage box 102 in US 2009/0044736 (though with apertures for receiving four bolts 12 instead of two bolts 114), and the bolts 12 may be similar or equivalent to carriage bolts 114 in US 2009/0044736. The bolts 12 pass through the apertures 112 such that only the heads of the bolts are accessible outside the safe 10. Nuts or other unshown locking structure is located inside the safe 10 for receiving the bolts 12 and coupling the safe 10 to the bracket 100; this locking structure may be similar or equivalent to the nuts 116 in US 2009/0044736.

In FIG. 5, the bracket 100 is positioned such that the distal portion 120 (and particularly the walls 122) extends generally vertically. A horizontal flat post 500 passes between the safe 10 and the bracket 100, and between the apertures 112. The interaction faces 111 of the proximal portions 110 abut a generally planar face 502 of the post 500, and the bolts 12 and locking structure couple the bracket 100 to the safe 10. By centering the post 500 between the apertures 112, the bolts 12 may be separated from the post 500—and thus may not scratch or mar the post 500.

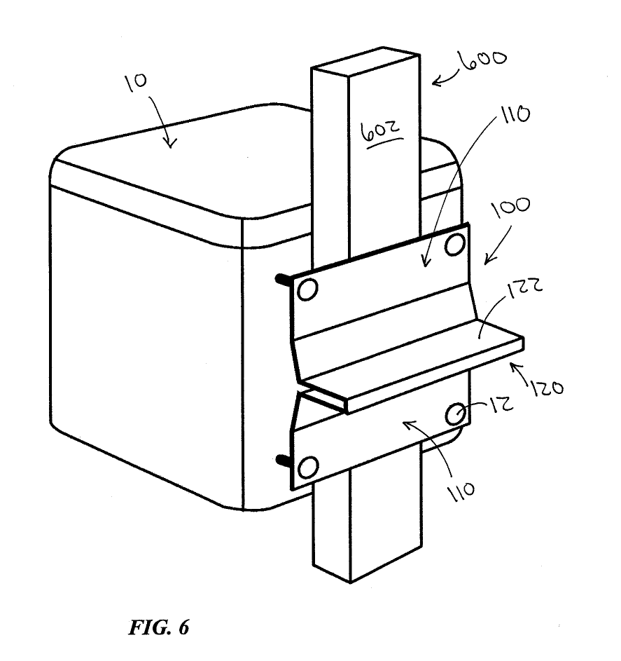

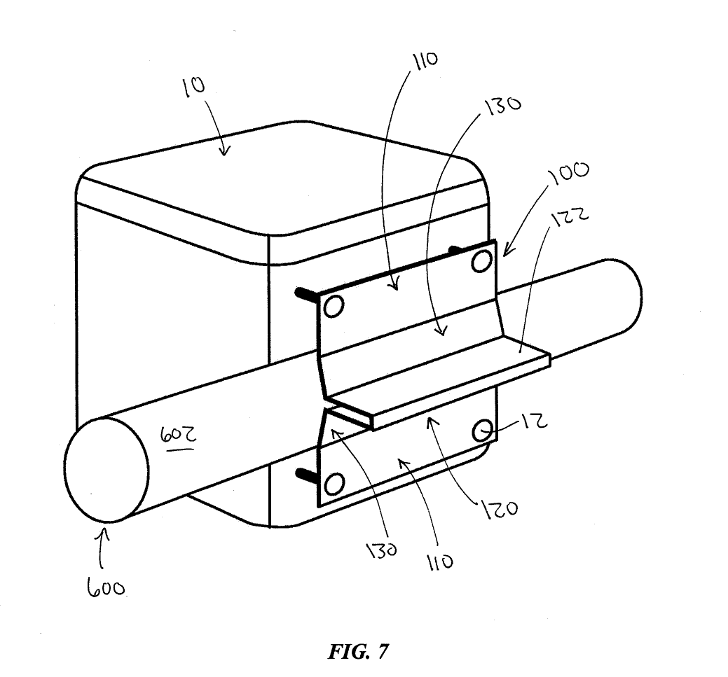

In FIG. 6, the bracket 100 is positioned such that the distal portion 120 (and particularly the walls 122) extends generally horizontally. A vertical flat post 600 passes between the safe 10 and the bracket 100, and between the apertures 112. The interaction faces 111 of the proximal portions 110 abut a generally planar face 602 of the post 600, and the bolts 12 and locking structure couple the bracket 100 to the safe 10. By centering the post 600 between the apertures 112, the bolts 12 may be separated from the post 600—and thus may not scratch or mar the post 600. While the vertical post 600 may have been located between the bolts 12 with the bracket 100 positioned as in FIG. 5 (such that the post 600 extends generally parallel to the distal portion 120), the post 600 may not be able to sufficiently contact the interaction faces 111 in such an arrangement; a corner of the post 600 could slip adjacent the distal portion 120 or one of the transition portions 130.

In FIG. 7, the bracket 100 is positioned such that the distal portion 120 (and particularly the walls 122) extends generally horizontally. A horizontal round post 700 passes between the safe 10 and the bracket 100, and between the apertures 112. The interaction faces 131 of the transition portions 130 abut a rounded face 702 of the post 700, and the bolts 12 and locking structure couple the bracket 100 to the safe 10. The post 700 is centered between the proximal portions 110 due to the interaction between the rounded face 702 and the interaction faces 131. As such, the bolts 12 are separated from the post 700 and may not scratch or mar the post 700. The points of contact between the post 700 and the interaction faces 131 depends on the diameter of the post 700, and the bracket 100 may be used with round posts of different diameters.

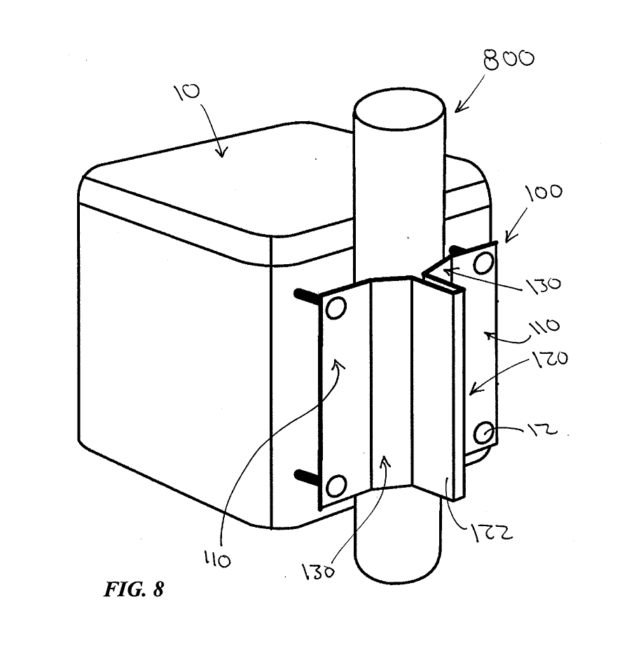

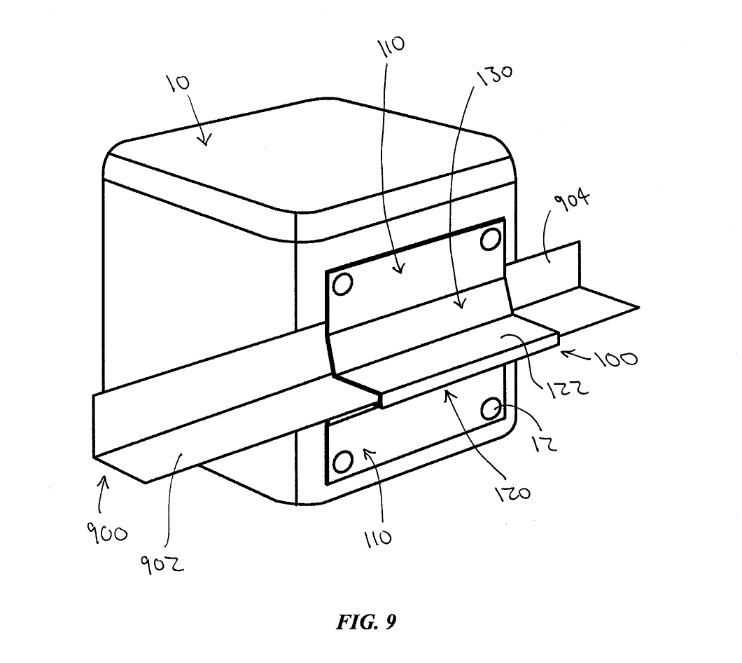

FIG. 8 shows the bracket 100 and safe 10 used with a vertical round post 800. The primary difference between the configurations in FIG. 7 and FIG. 8 is that the bracket 100 is positioned such that the distal portion 120 (and particularly the walls 122) extends generally vertically in FIG. 8 to allow interaction with the post 800. The post 800 interacts with the bracket 100 generally similar to the interaction between the post 700 and the bracket 100 discussed above.

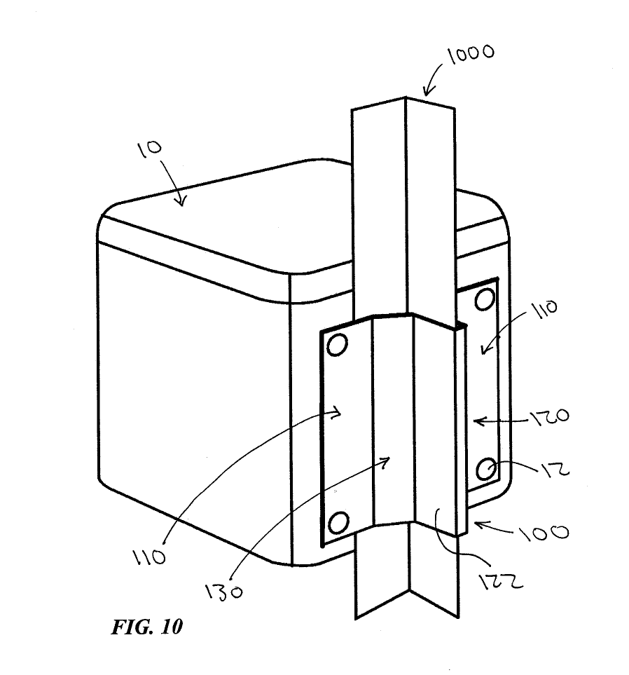

In FIG. 9, the bracket 100 is positioned such that the distal portion 120 (and particularly the walls 122) extends generally horizontally. A horizontal L-shaped frame (or “post”) 900 passes between the safe 10 and the bracket 100, and between the apertures 112. One leg 902 of the L-shaped frame 900 extends inside the cavity 129 of the distal portion 120, and another leg 904 of the L-shaped frame 900 extends between one of the interaction faces 111 and the safe 10.

FIG. 10 shows the bracket 100 and safe 10 used with a vertical L-shaped frame (or “post”) 1000. The primary difference between the configurations in FIG. 9 and FIG. 10 is that the bracket 100 is positioned such that the distal portion 120 (and particularly the walls 122) extends generally vertically in FIG. 10 to allow interaction with the frame 1000. The frame 1000 interacts with the bracket 100 generally similar to the interaction between the frame 900 and the bracket 100 discussed above.

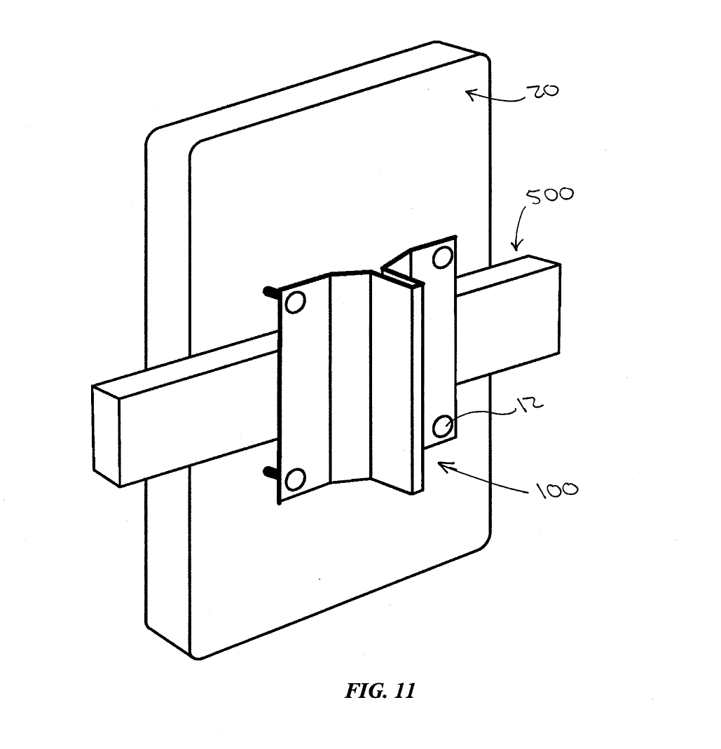

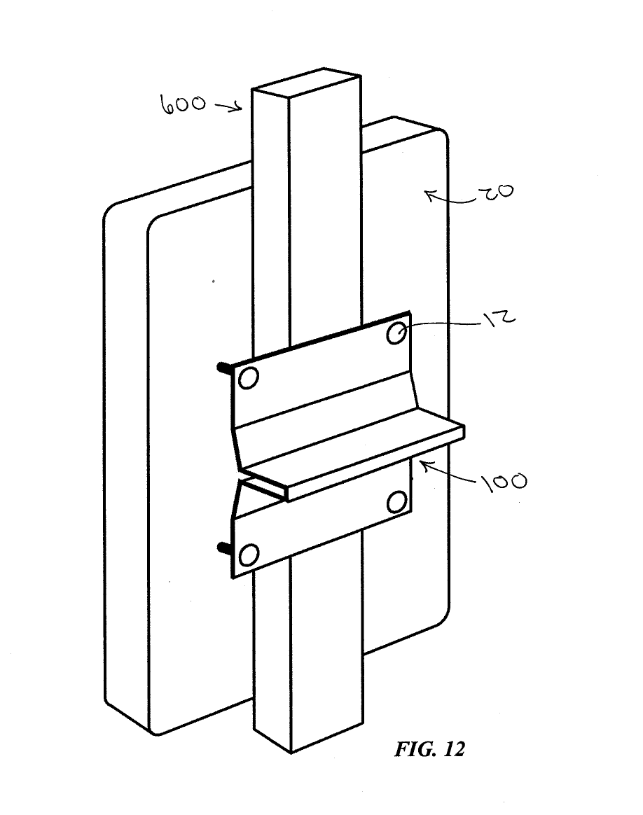

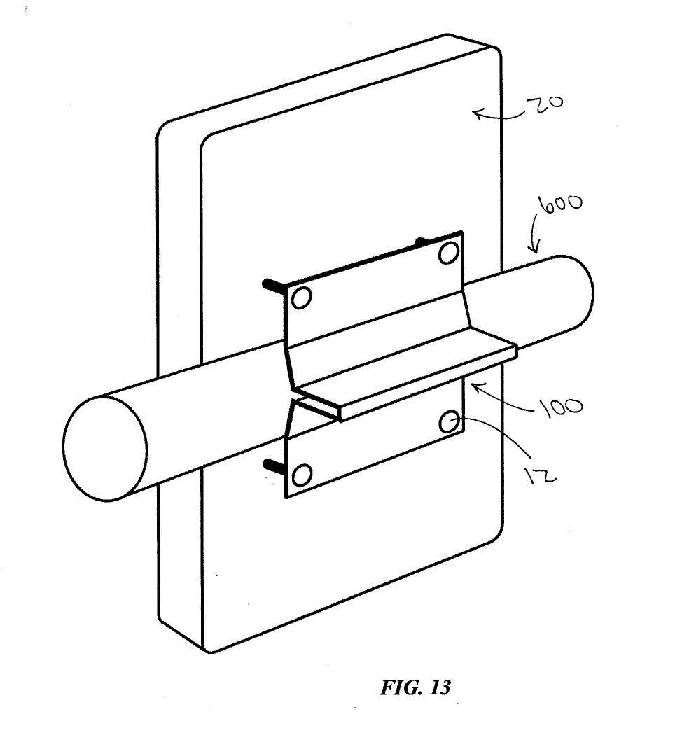

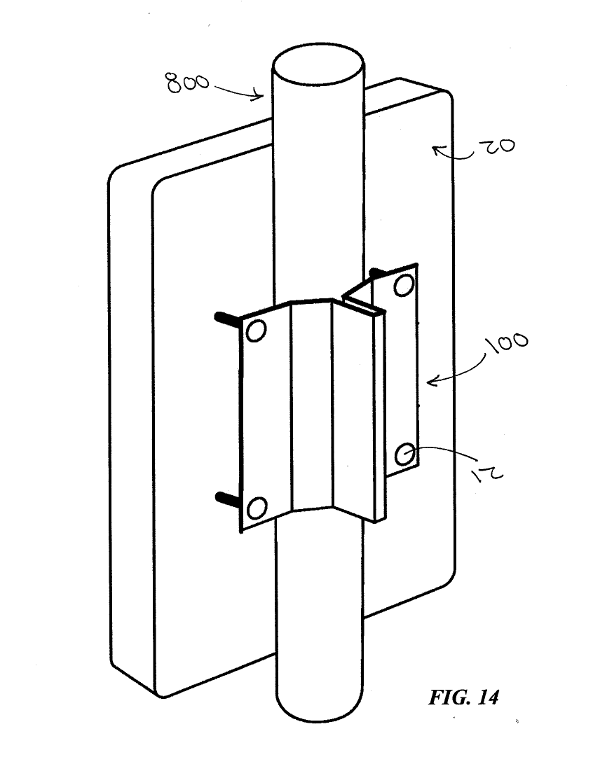

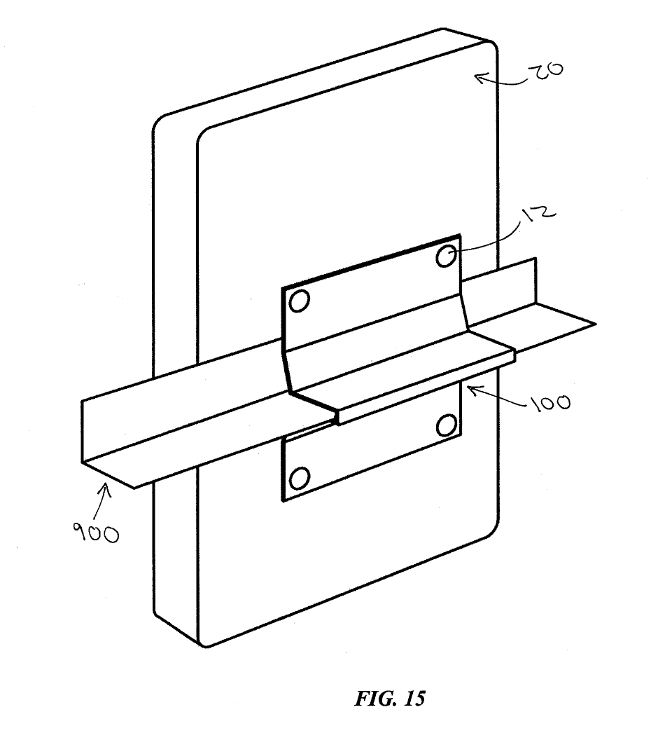

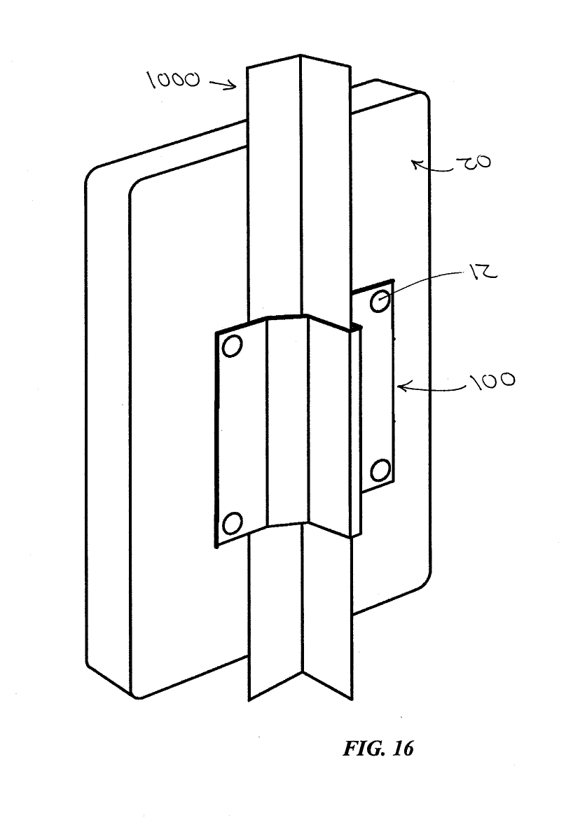

FIGS. 11 through 16 show the bracket 100 in more examples of use. In these figures, a portable safe 20 and bolts 12 are shown with the bracket 100. These examples differ from those in FIGS. 5 through 10 in that the safe 20 may be particularly configured to house a laptop computer.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims.

1. A bracket for use in securing a portable locking item, comprising:
a pair of proximal portions, each proximal portion having an interaction face and at least one aperture for passing a fastener therethrough, the proximal portion interaction faces being generally parallel and coplanar with one another;
an outwardly-extending distal portion between the proximal portions, the distal portion having a pair of sidewalls spaced apart from one another; and
a pair of transition portions, a respective transition portion being between each proximal portion and the distal portion, each transition portion having an interaction face extending at an angle from a respective proximal portion interaction face to a respective distal portion sidewall.

2. The bracket of claim 1, wherein each interaction face is generally planar, and wherein the interaction faces are generally mirror images of one another about the distal portion.

3. The bracket of claim 2, wherein:
each proximal portion has two generally rectangular apertures; and
center axes of the apertures in one proximal portion are not parallel to one another, and are generally aligned with center axes of the apertures in the other proximal portion.

4. The bracket of claim 3, wherein:
each distal portion sidewall has a proximal end and a distal end; and
the distal portion has an end wall coupling the distal ends of the distal portion sidewalls to one another.

5. The bracket of claim 4, wherein the distal portion sidewalls are generally parallel to one another.

6. The bracket of claim 4, wherein the distal portion sidewalls are flared away from the distal portion end wall.

7. The bracket of claim 4, wherein the interaction faces of the proximal portions and the interaction faces of the transition portions are defined by bending a single piece of metal.

8. The bracket of claim 1, wherein:
each proximal portion has two generally rectangular apertures; and
center axes of the apertures in one proximal portion are not parallel to one another, and are generally aligned with center axes of the apertures in the other proximal portion.

9. A bracket for use in securing a portable locking item, comprising:
first and second proximal portions configured to simultaneously contact a generally planar environmental item, each proximal portion having at least one aperture for passing a fastener therethrough;
an outwardly-extending distal portion between the proximal portions, the distal portion being configured to receive one leg of an L-shaped environmental item therein;
a first transition portion between the first proximal portion and the distal portion; and
a second transition portion between the second proximal portion and the distal portion;
wherein the first and second transition portions collectively present a pair of faces angled relative to one another for simultaneously contacting a generally cylindrical environmental item.

10. The bracket of claim 9, wherein the angled faces of the transition portions are generally mirror images of one another about the distal portion.

11. The bracket of claim 10, wherein:
each proximal portion has two generally rectangular apertures; and
center axes of the apertures in the first proximal portion are not parallel to one another, and are generally aligned with center axes of the apertures in the second proximal portion.

12. The bracket of claim 11, wherein:
the distal portion having a pair of sidewalls spaced apart from one another;
each distal portion sidewall has a proximal end and a distal end; and
the distal portion has an end wall coupling the distal ends of the distal portion sidewalls to one another.

13. The bracket of claim 12, wherein the distal portion sidewalls are generally parallel to one another.

14. The bracket of claim 12, wherein the distal portion sidewalls are flared away from the distal portion end wall.
